(19) United States
(12) Patent Application Publication
(10) Pub. No.: US 2021/0256613 A1
(43) Pub. Date: Aug. 19, 2021

(54) Investment Fund Investors Shareholder Advocacy Mechanism

(71) Applicant: Ridgeline Research, LLC, Darnestown, MD (US)

(72) Inventor: William Edward Flaig, JR., Darnestown, MD (US)

(73) Assignee: Ridgeline Research, LLC, Darnestown, MD (US)

(21) Appl. No.: 17/123,354

(22) Filed: Dec. 16, 2020

Related U.S. Application Data
(60) Provisional application No. 62/977,546, filed on Feb. 17, 2020.

(51) Int. Cl. G06Q 40/06

(52) U.S. Cl. CPC G06Q 40/06; G06Q 2230/00

(57) ABSTRACT

A method for managing financial investment funds with two or more investors where investors nominate an investment for a vote by a plurality of the investors who decide if the investors of the fund will request that the fund avoids the investment. The fund manager can take the investor vote account into consideration when rebalancing the fund, but the manager is not bound by the vote.

### BACKGROUND

### Technical Field of the Method

The present disclosure relates generally to managed investment. Some embodiments relate to mutual fund management.

### Description of the Related Art

Generally, a management team manages investment funds. The management team generally controls the manner of investment according to a proprietary, undisclosed system. Some management teams control fund investment through a disclosed investment management philosophy. Another form of investment management philosophy allows the investors to control the investment fund by a weighted vote. These investment funds hold a binding vote on whether to buy or sell investments within the fund.

### BRIEF DESCRIPTION OF THE DRAWINGS

FIG. 1 is a block diagram illustrating a list of potential modules in an investor interface of an investment portal, in an example embodiment.

FIG. 2 is a block diagram illustrating a list of potential administrative powers that may be performed or initiated by a fund manager in a manager interface in the investment portal, in an example embodiment.

FIG. 3 is a flow diagram of an investment avoidance nomination process, according to an embodiment.

FIG. 4 is a flow diagram of an investment removal from an avoidance list nomination process, according to an embodiment.

FIG. 5 is a flow diagram of an investment purchase nomination process, according to an embodiment.

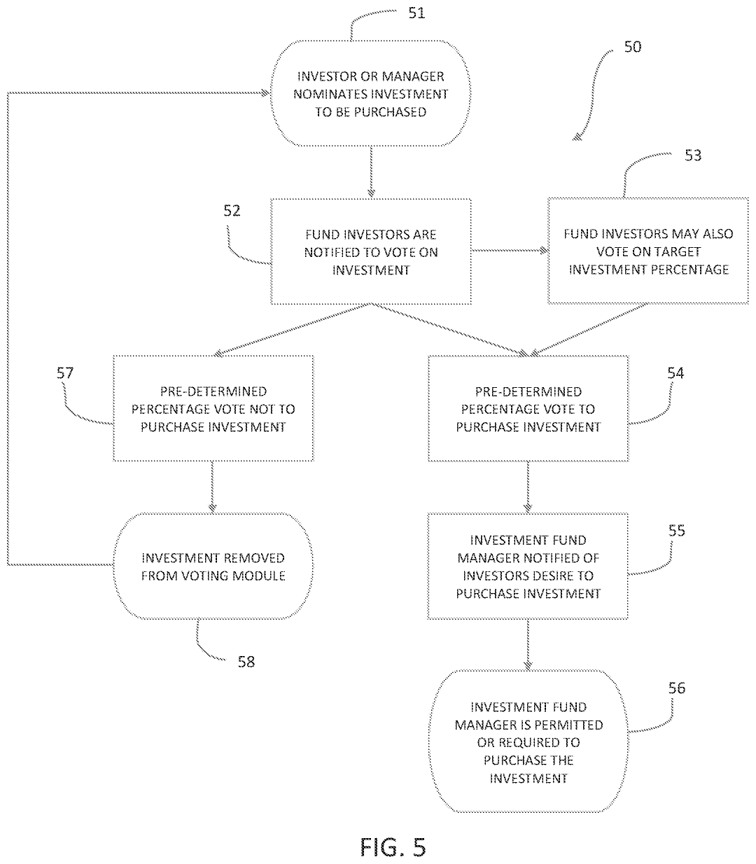

FIG. 6 is a block diagram of multiple types of investment funds, in an example embodiment.

FIG. 7 is a block diagram of the computing architecture on an adapter, in an example embodiment.

Further embodiments, features, and advantages of the present invention, as well as the operation of the various embodiments of the present invention, are described below with reference to the accompanying drawings.

### Overview

Presented herein are systems and methods for shareholder advocacy in pooled investment products. Individual investors may purchase shares of the investment fund, which is to be managed by an investment fund manager. The individual investors are empowered to nominate various investments for avoidance, removal from an avoidance list, or purchase based on their own standards or values. Once an investment is nominated, the other investors of the investment fund may be notified and invited to vote on the investment. Results of this vote are provided to the investment fund manager, who may or may not be bound to act according to the results of the vote.

### DETAILED DESCRIPTION

An embodiment of the present invention is now described with reference to the figures. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and applications.

An implementation of the investment method described herein relates to shareholder advocacy methods for pooled investment products. A professional investment fund manager pools money from two or more investors who collectively may have an input in the investment process. The investment fund manager can be an individual manager, a team comprised of a plurality of managers, or a computer program logic. The investment fund manager creates an investment fund comprising investments in one or more securities or other investments. The investment fund manager may set a philosophy for purchasing and divesting investments in the fund. An individual investor or a group of investors may purchase shares of the investment fund knowing the investment fund manager's stated philosophy for managing the investment fund. The investment fund manager may adjust the fund's investments over time and as the fund grows. In an embodiment, the investment fund manager sets a threshold ownership share for investors to nominate an investment for a vote as to whether the investment should be pursued, avoided, or sold.

In an embodiment, an investment portal 10 resides on a server. Software on the server may embody a front end and a back end, as described below. In the embodiment, the software creates two graphic interfaces for the front end: an investor interface and a manager interface.

In an embodiment, investors access the investor interface through an internet-based web browser on a computer or cellular phone, or through a phone-based proprietary application. The investment fund manager provides the investment portal 10 for the investors to access information regarding the investment fund and/or to provide information to the manager. The investor interface may require a user account, approved by the manager, for investors to access the investment portal. The portal may have one or more modules having a variety of functions.

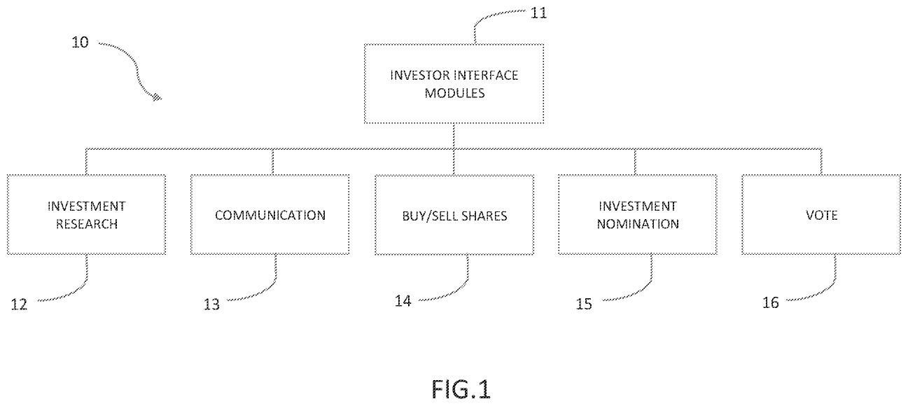

FIG. 1 illustrates various modules provided to investors in the investor interface 11, according to an embodiment. These modules can include, but are not limited to, a module for investors to research investments and securities 12, a module for investors to communicate with other investors and the investment fund manager 13, a module to purchase or sell shares of the investment fund 14, a module for investors to nominate an investment to avoid holding or to boycott, to remove an investment from an avoidance list, or to purchase an investment 15, and a module for investors to vote on the nominated investment 16

In an embodiment, the investment fund manager accesses the manager interface through an internet-based web browser on a computer or cellular phone, or through a phone-based proprietary application. The interface allows the investment fund manager to log in to the investment portal 10 and administer the portal, The portal may provide one or more administrative tasks to the investment fund manager.

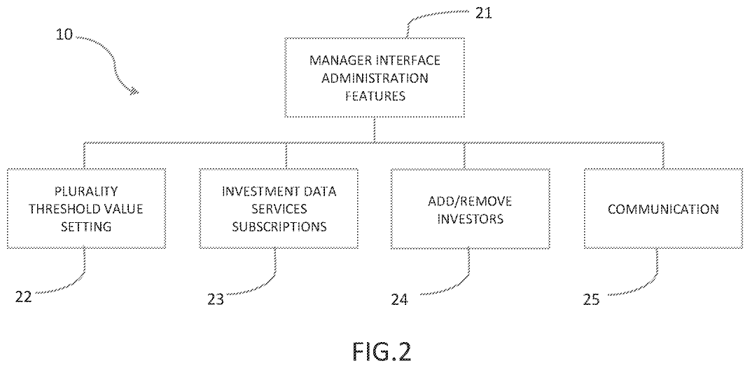

FIG. 2 illustrates various administrative tasks available to the manager in the manager interface 21, according to an embodiment. These tasks may include, but are not limited to, setting the plurality threshold 22, choosing which investment data services the fund subscribes to 23, adding or removing investors as users in the portal 24, and communicating with investors 25.

On the back end, the software reads or receives information regarding the percentage share of the investment fund that each investor owns. The server contains software to administer the vote count. The software initiates a vote measure when an investment is nominated for a vote by an investor in the nomination module 15. When the software initiates the vote count, the software calculates each investor's ownership share of the investment fund. The software may notify investors in the communication module 13 that a vote has commenced. The software tallies each investor's vote weighted by the investor's ownership share. The software ends the vote when the weighted tally meets a pre-determined threshold. Otherwise, if the manager or nominator chooses to specify a vote time limit, the software also ends the vote after the time limit if the vote does not reach a pre-determined plurality. After the software ends the vote, the software communicates the vote result to all investors and the manager in the communication module of the investor interface 13 and the manager interface 25.

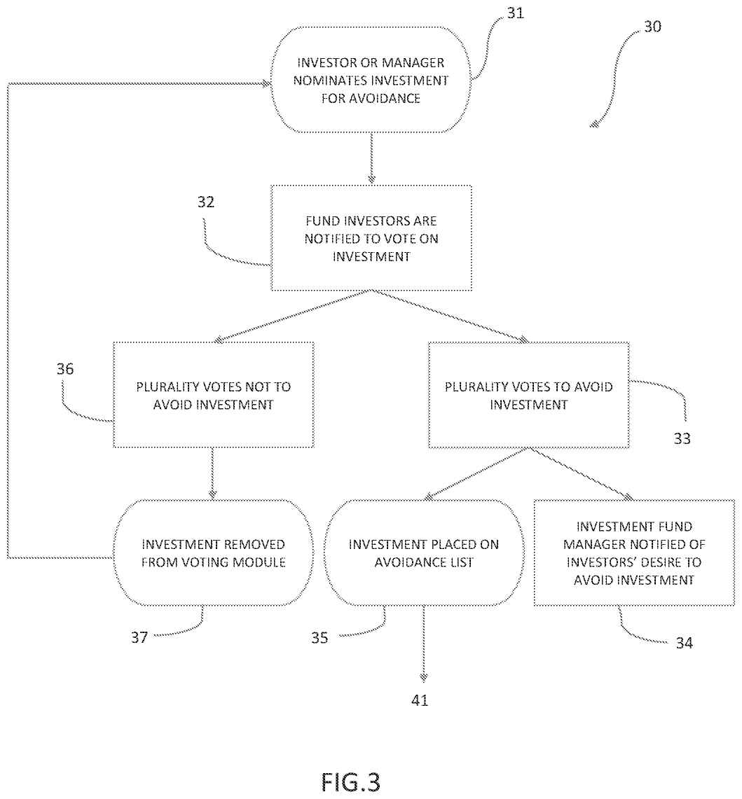

The process by which an investor nominates an investment for avoidance 30 is illustrated in FIG. 3, according to an embodiment. The investment portal includes a module 15 for an individual investor to nominate an investment to avoid holding or to boycott 31. The investor can nominate an investment for avoidance for any reason that the investor chooses, such as not aligning with the investor's standards or values. After an investor nominates such an investment, the other investors are notified of the nomination 32 through the communication module of the investor interface 13. The investors may vote to avoid or boycott the investment in the investment voting module 16. If a pre-determined plurality of investors vote to avoid this investment 33, this result will be communicated to the investment fund manager 34. If the pre-determined plurality of investors vote that an investment should be avoided or boycotted, the investment fund manager may avoid or sell shares in the investment and the investment is placed on the avoidance list 35. The avoidance list is stored in the memory of the server or in some other accessible location and contains all the various investments which are currently being avoided by the investment fund. Alternatively, if the pre-determined plurality of investors vote not to avoid the investment 36, the investment is removed from the voting module 37. Investments which are not avoided and are removed from the voting module are still eligible to be nominated for avoidance in the future. The investors' votes may be weighted by each investor's percent investment in the fund, or by another weighted voting method.

In one embodiment, the results of the investors' vote in the avoidance nomination process may not bind the investment fund manager. The investment fund manager may take the investors' vote(s) into consideration when evaluating the investment portfolio, when acquiring new investments, or when selling investments held by the investment fund. In a separate embodiment, the investment fund manager may be bound by the result of the investors' vote. In this embodiment, the investment fund manager must sell any boycotted investments that the investment fund holds within a pre-determined period of time and must not purchase any more of the avoided investment.

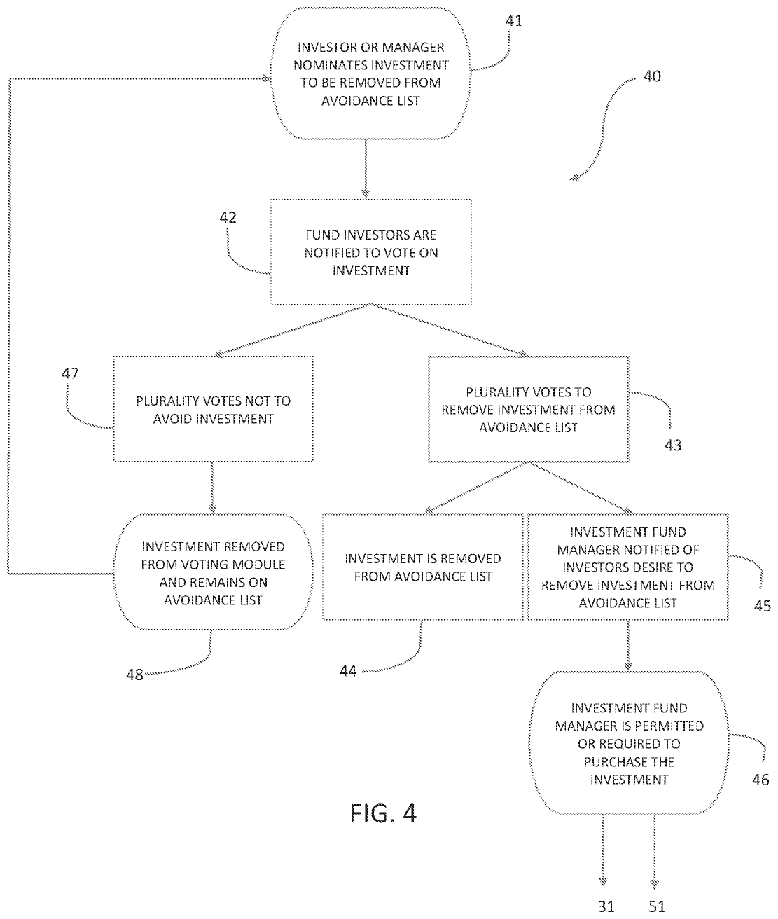

The process by which an investor nominates an investment to be removed from an avoidance list 40 is illustrated in FIG. 4, according to an embodiment. An investor may nominate an investment to be removed from the avoidance list 41. After the investor nominates the investment for removal from the avoidance list, all fund investors are notified of the nomination 42 through the communication module of the investor interface 13. The investors may vote to remove the investment from the avoidance list in the investment voting module 16. If a pre-determined plurality of investors vote to remove an investment from the avoidance list 43, the investment is removed from the avoidance list 44 and this result will be communicated to the investment fund manager 45. The investment fund manager may or may not be required to purchase the investment 46. If the investors instead vote to keep the investment on the avoidance list 47, then the investment is removed from the voting module and remains on the avoidance list 48. Investments which are not removed from the voting module are still eligible to be nominated for removal from the avoidance list in the future. The investors' votes may be weighted by each investor's percent investment in the fund, or by another weighted voting method.

In one embodiment, the results of the investors' vote in the avoidance list removal process may not bind the investment fund manager. The investment fund manager may take the investors' vote(s) into consideration when evaluating the investment portfolio, when acquiring new investment, or when selling investments held by the investment fund. In a separate embodiment, the investment fund manager may be bound by the result of the investors' vote. In this embodiment, the investment fund manager must purchase the investment which was removed from the avoidance list within a pre-determined period of time.

The process by which an investor nominates an investment to be purchased 50 is illustrated in FIG, 5, according to an embodiment. Investors may nominate an investment for the investment fund manager to purchase 51. After the investor nominates the investment for purchase, all fund investors are notified of the nomination 52 through the communication module of the investor interface 13. The investors may vote to purchase the investment in the investment voting module 16. In addition, the investors may vote on a target investment percentage 53 should a pre-determined plurality of investors vote to purchase the investment. If a pre-determined plurality of investors votes to purchase the investment 54, this result will be communicated to the investment fund manager 55. The investment fund manager may or may not be required to purchase the investment 56. If the investors instead vote not to purchase the investment 57, then the investment is removed from the voting module 58. Investments which are not purchased are still eligible to be nominated for purchase in the future. The investors' votes may be weighted by each investor's percent investment in the fund, or by another weighted voting method.

In one embodiment, the results of the investors' vote in the purchase process may not bind the investment fund manager. The investment fund manager may take the investors' vote(s) into consideration when evaluating the investment portfolio, when acquiring new investment, or when selling investments held by the investment fund. In a separate embodiment, the investment fund manager may be bound by the result of the investors' vote. In this embodiment, the investment fund manager must purchase the investment within a pre-determined period of time.

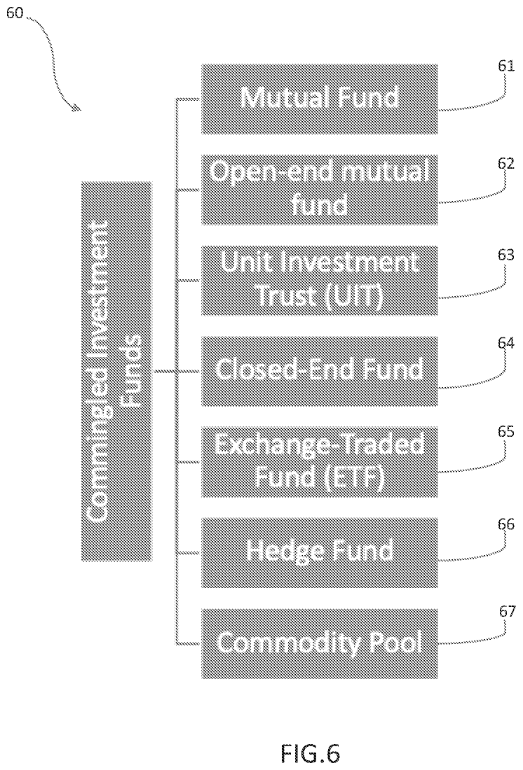

FIG. 6 illustrates various forms the investment fund may take. Embodiments of the investment fund 60 may include, but are not limited to, mutual funds 61, other types of commingled investment structures and pools such as open-end mutual funds 62, unit investment trusts (UITs) 63, closed-end funds 64, exchange-traded funds (ETFs) 65, hedge funds 66, or commodity pools 67. Another embodiment may involve an otherwise passively-managed fund. Here, the investment fund's investment portfolio is normally designed to match a financial market index but may be modified by the processes described above.

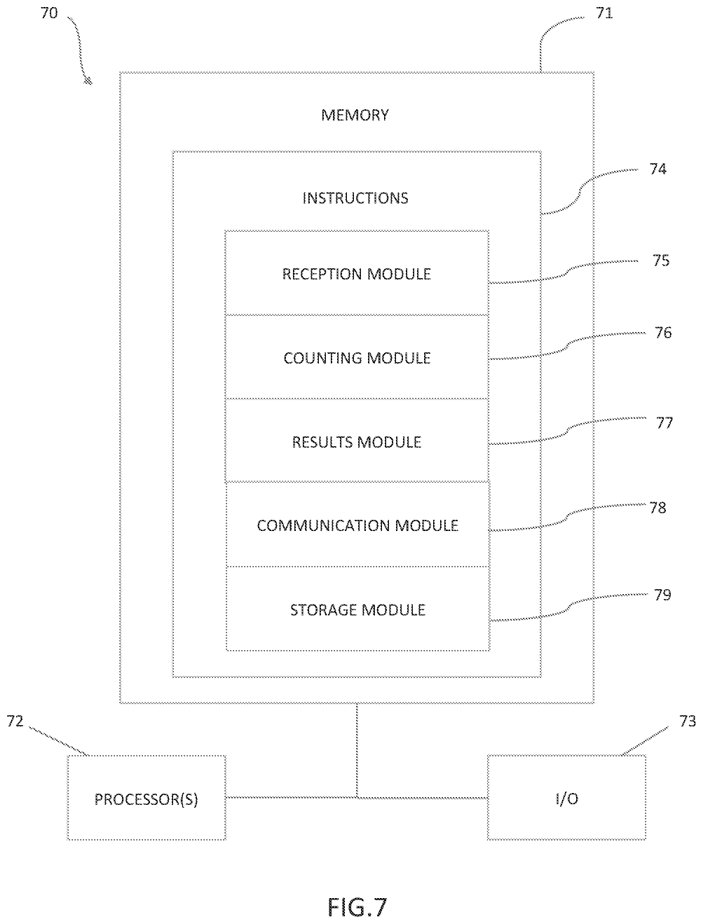

In an embodiment, the above processing is performed by software or firmware in an adapter. Software or firmware embodiments are illustrated in FIG. 7. Computing system 70 includes one or more memory devices, shown collectively as memory. Memory 71 is in communication with one or more programmable processors or controllers 72 and input/output ports and devices shown collectively as I/O 73.

Memory 71 may comprise read only memory (ROM), random access memory (RAM), magnetic disk storage media devices, optical storage media devices, flash memory devices, electrical, optical, or other physically tangible (i.e., non-transitory) memory storage devices. Memory 71 stores data as well as executable instructions 74. Instructions 74 are executable on processor(s) 72. The processor(s) 72 comprise, for example, a microprocessor or microcontroller that executes instructions 74. Thus, in general, the memory 71 may comprise one or more tangible (non-transitory) computer readable storage media (e.g., memory device(s)) encoded with software or firmware that comprises computer executable instructions. When the software is executed (by the processor(s) 72) the software or firmware is operable to perform the operations described herein.

In the illustrated embodiment, the executable instructions 74 may include several modules. These include a nomination reception module 75, configured to receive nominations for investments from investors as well as votes on these nominated investments from investors. Executable instructions 74 may also include a counting module 76, configured to count or tally the results of the votes regarding a nominated investment. Executable instructions 74 may also include a results module 77, configured to determine whether the vote count surpassed the threshold value set by the investment fund manager. Executable instructions 74 may also include a communication module 78, configured to inform the manager of the investment fund that investors wish to avoid a specific investment, should the investors' votes surpass the pre-determined threshold, and permits investors to communicate between themselves and with the manager. Executable instructions 74 may also include a storage module 79, configured to display investors' past voting decisions.

What is claimed is:

1. A method for managing financial investment funds comprising:
receiving a nomination for an investment to be voted on by a plurality of investors in a financial investment fund;
receiving votes from the investors to decide if the fund will avoid the investment;
totaling the votes of the investors for a total vote count;
determining if the total vote count is above a threshold set by a manager of the investment fund; and
informing the manager that the investors want to avoid the investment, if the total vote count surpasses the set threshold.

2. The method of claim 1, wherein the investment fund is one of an open-end mutual fund, a unit investment trust (UIT), a closed-end fund, an exchange traded fund (ETF), a hedge fund, or a commodity pool.

3. The method of claim 1, wherein an investor must own at least a predetermined number of shares designated by the fund manager to nominate an investment for a vote.

4. The method of claim 1, wherein the fund manager is not bound by the investor vote to act.

5. The method of claim 1, wherein the fund manager is bound by the investor vote to not purchase any avoided investment if the threshold number of investors votes to avoid the investment.

6. The method of claim 1, wherein the fund manager is bound by the investor vote to sell any avoided investment if the threshold number of investors votes to avoid the investment.

7. The method of claim 1, wherein the threshold set by the manager is changeable by the manager upon conclusion of voting.

8. The method of claim 1, further comprising maintaining an online portal, with modules that can supply features to investors, the features comprising one or more of providing investment research tools, facilitating investment nominations, communicating between the fund manager and the investors, facilitating the purchase or sale of shares of the investment fund, and facilitating a vote on nominated investments.

9. The method of claim 1, further comprising receiving a nomination of a previously avoided investment to have its avoidance reversed and permitting the fund manager to maintain or invest in the previously avoided investment if at least a predetermined number of investors vote in agreement.

10. The method of claim 1, wherein the manager comprises computer program logic and the investment fund is passively managed, at least in part.

11. One or more computer readable non-transitory storage media encoded with computer-readable instructions that, when executed by a processor, cause the processor to:
receive a nomination for an investment to be voted on by a plurality of investors in a financial investment fund;
receive votes from investors to decide if the fund will avoid the investment;
total the votes of the investors for a total vote count;
determine if the total vote count is above a threshold set by a manager of the investment fund; and
inform the manager that the investors want to avoid the investment, if the total vote count surpasses the set threshold.
